(19) United States
(12) Patent Application Publication
(10) Pub. No.: US 2003/0205877 A1
(43) Pub. Date: Nov. 6, 2003

(54) Stackable dolly for supporting stackable trays having prestressed sections

(76) Inventors: Donald Verna, Wixom, MI (US); Richard C. Kruyer, Grand Blanc, MI (US); Douglas Cox, Lennon, MI (US)

Correspondence Address: ATTN: Thomas D. Helmholdt, YOUNG & BASILE, P.C., SUITE 624, 3001 WEST BIG BEAVER ROAD, TROY, MI, 48084-3107, US

(21) Appl. No.: 10/425,140

(22) Filed: Apr. 28, 2003

Related U.S. Application Data
(63) Continuation-in-part of application No. 10/397,165, filed on Mar. 26, 2003.
(60) Provisional application No. 60/378,178, filed on May 6, 2002.
(60) Provisional application No. 60/377,725, filed on May 3, 2002.

(51) Int. Cl. B62B 3/00

(52) U.S. Cl. 280/79.11

(57) ABSTRACT

A tray having prestressed sections including a domed shaped bottom and a merchandising window. The window includes a surface parallel to the dome shaped bottom. When the tray is subjected to a load, the dome and the surface of the merchandising window become substantially planar. The front of the tray also includes vertically extending corners that are angled inwardly toward one another from an outer top end to an inner lower end when the tray is empty. When the tray is loaded, the corners deflect toward a vertically extending parallel relationship with respect to one another. The corners adjacent the rear of the tray are fixed relative to one another. A stackable dolly supports stackable trays for allowing movement of stacked trays from one location to another on casters or wheels connected to the stackable dolly. The dollys are stackable with respect to one another when not in use. Each dolly can have recessed notches to receive the casters or wheels of an adjacent upper stacked dolly. The recessed notches can include a ramp extending in a direction aligned with one another and/or can be positioned to extend in a direction at offset angular orientations with respect to one another for improved stacking stability of the dollys.

### CROSS-REFERENCE TO RELATED APPLICATIONS

This application claims the benefit of provisional patent application serial No. 60/378,178 for a DOLLY filed on May 6, 2002, and is a continuation-in-part of provisional patent application serial No. 60/377,725 for a STACKABLE TRAY HAVING PRESTRESSED SECTIONS filed on May 3, 2002, and a continuation-in-part of regular utility patent application Ser. No. 10/397,165 for a STACKABLE TRAY HAVING PRESTRESSED SECTIONS filed on Mar. 26, 2003, all of which are incorporated by reference herein in their entirety.

### FIELD OF THE INVENTION

The invention relates to multi-purpose reusable load-bearing trays stackable in three positions, and more particularly to a stackable dolly for supporting stackable trays.

### BACKGROUND OF THE INVENTION

Plastic trays that are stackable and/or nestable can be desirable to maintain cargo such as material and/or products. However, existing trays are not as efficient as desired. Specifically, existing trays can deform under loading in an undesirable manner such that the tray appears to sag, and existing trays when stacked are not easily moveable.

### SUMMARY OF THE INVENTION

The present invention provides a stackable dolly for supporting one or more stackable trays for movement. The dolly can include at least one rail for aligning a tray relative to the dolly and/or at least one projection to limit movement of the tray in longitudinal and/or transverse movement with respect to the dolly. The stackable tray can include one side defining an opening such as a merchandising window. The tray can also include a domed bottom. The side of the tray defining the merchandising window can include a portion extending substantially parallel to the domed bottom. The structure of the portion and the domed bottom provide a prestressed section such that the arcuate domed bottom and the arcuate portion of the one side are flattened, or straightened when material and/or goods are loaded with respect to the tray and the tray does not sag.

The present invention also provides recessed corners on opposite sides of the merchandising window. Specifically, the walls of the tray on opposite sides of the merchandising window can be angled inwardly with respect to the opposite corners. When material and/or goods are received by the tray, the tray can be deflected such that the corners deflect with respect to the bottom of the tray and align to be generally perpendicular with the respective opposing corners.

The present invention provides a tray having a front, first side, a second side, a rear and a bottom. The front includes an opening positioned between first and second ends of the front. The bottom is shaped, at least partially, as a dome. When the tray is subjected to a load, the dome portion of the bottom is flattened.

The opening of the front can include a surface that extends parallel to the dome portion of the bottom. When the tray is empty, the surface can extend along an arched path corresponding to the profile of the dome. When the tray is subjected to a predetermined load, the surface of the opening can flatten out and define a plane. The rear can also include an opening. The opening of the rear can include a surface that is flat or planar when the tray is empty and when the tray is loaded.

The front is integrally formed with the first side at a first end of the front and is integrally formed with the second side at a second end. A first vertically extending corner can be defined between the first side and the front, and a second vertically extending corner can be defined between the second side and the front. The first and second corners can be initially angled outwardly toward one another from an outer top end to a lower inner end when the tray is empty. A third vertically extending corner can be defined between the rear and the first side, and a fourth vertically extending corner can be defined between the rear and the second side. A horizontal distance between the upper and lower ends of the third and fourth vertically extending corners can be the same when the tray is empty and when the tray is loaded.

The first and second sides can twist when the tray is subjected to a predetermined load. For example, top portions of the first and second corners can deflect with respect to the bottom of the tray when the tray is subjected to a load, moving closer to one another. On the other hand, the third and fourth corners are fixed rigidly with respect to the bottom to minimize any deflection under loads.

The dome defined by the bottom can be centered with respect to the tray bottom or can be positioned closer to the front. For example, the front can include a bottom portion that defines an arched surface when the tray is empty and a substantially planar surface when the tray is loaded. A bottom portion of the rear can define a substantially planar surface when the tray is empty and when the tray is loaded.

The present invention includes a stackable dolly for supporting one or more stackable trays for movement. The tray includes a rail for aligning the tray relative to the dolly. The invention includes projections including longitudinal portions and transverse portions to limit movement of the tray relative to the dolly. The dolly can include notches for receiving casters when a plurality of dollys are stacked relative to one another. The notches can include ramps exteding in a direction aligned with one another and/or the ramps can be extending in directions offset at angular orientations with respect to one another.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a partial perspective view of a top half of a tray according to the present invention;

FIG. 2 is a partial perspective view of a bottom half of a tray according to the present invention;

FIG. 3 is a top plan view of a tray according to the present invention;

FIG. 4 is a bottom plan view of a tray according to the present invention;

FIG. 5 is a cross-sectional view of a tray according to the present invention having a domed bottom;

FIG. 6 is a front plan view of several trays stacked with respect to one another;

FIG. 7 is schematic cross-sectional view of a tray according to the present invention in a static or unloaded condition;

FIG. 8 is a schematic cross-sectional view of a tray according to the present invention in a loaded condition;

FIG. 9 is an perspective view of a stackable dolly for receiving a stackable tray according to the present invention; and

FIG. 10 is a top plan view of the dolly shown in FIG. 9.

### DESCRIPTION OF THE PREFERRED EMBODIMENT

The present invention is shown throughout the Figures. Some of the Figures include more than one tray according to the present invention, and in those Figures, different trays are designated with a common base numeral and differentiated with an alphabetic designation.

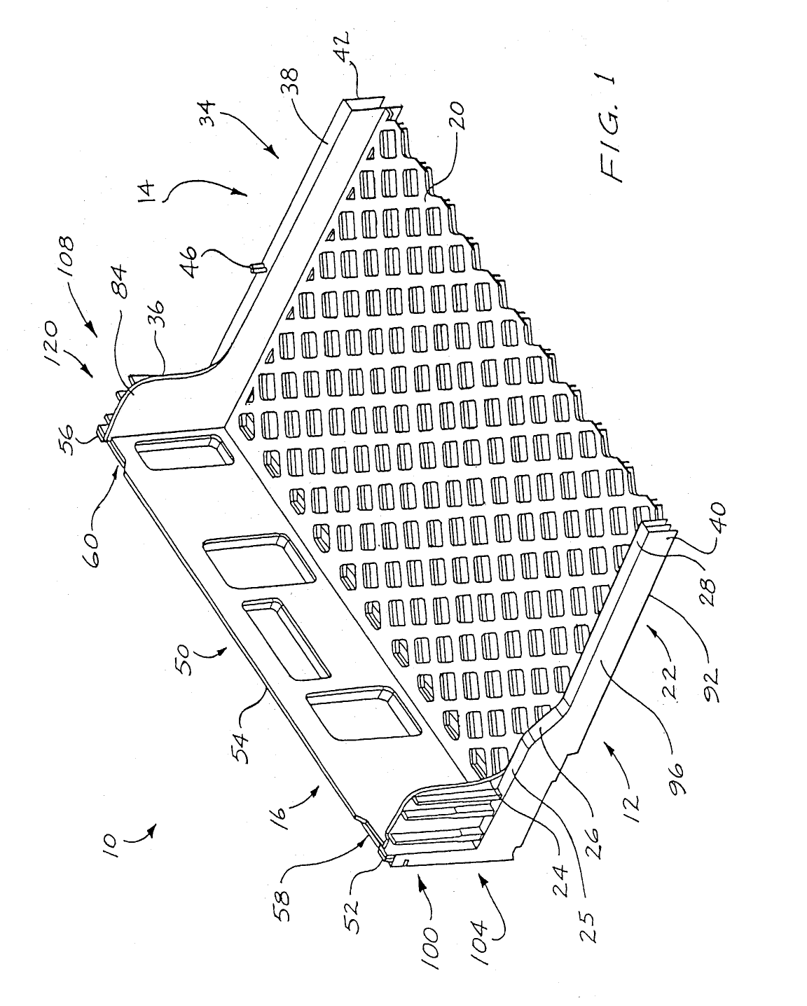

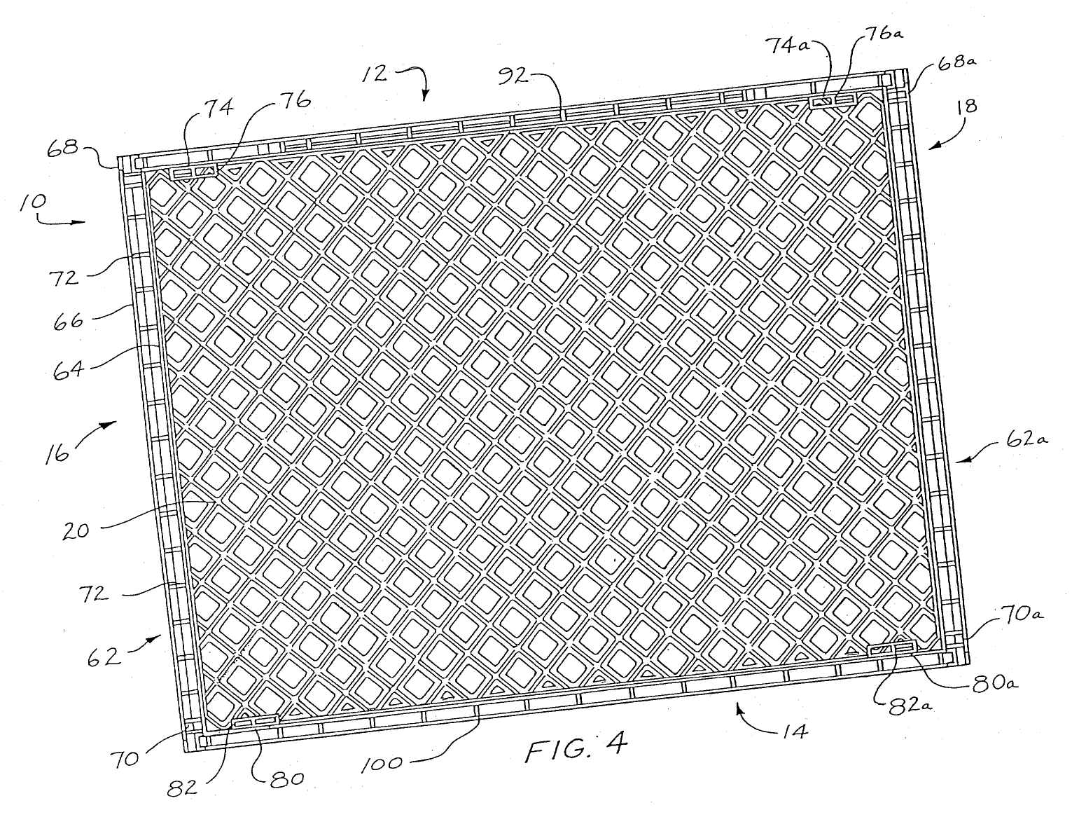

Referring now to FIGS. 1-5, the present invention provides a multi-purpose tray 10. The tray 10 can include a front 12, a rear 14, a first side 16, a second side 18, and a bottom 20. Each of these portions 12, 14, 16, 18 and 20 of the tray 10 can be integrally formed with respect to one another. The bottom 20 can extend in a transverse direction between the first side 16 and the second side 18 and in a longitudinal direction between the front 12 and the rear 14. The tray 10 can be fabricated from plastic in an injection molding process.

The front 12 can include an opening 22 defined by surfaces 24, 25, 26, 27, 28, 30, and 32. The surfaces 25, 26, 27, 28 and 30 can define a merchandising window. The rear 14 can include an opening 34 defined by surfaces 36 and 38. The opening 22 can be larger than the opening 34 to enhance the removal of material and/or products from the tray 10 from the front 12 and/or to enhance inspection of the material and/or products.

The front 12 and rear 14 can include walls 40 and 42, respectively, to enhance the structural integrity and/or rigidity of the tray 10. The wall 40 can include a rib 44 to enhance the structural rigidity of the front 12. Specifically, the wall 40 can be shorter than the wall 42, because of the merchandising window, and can be reinforced by the rib 44.

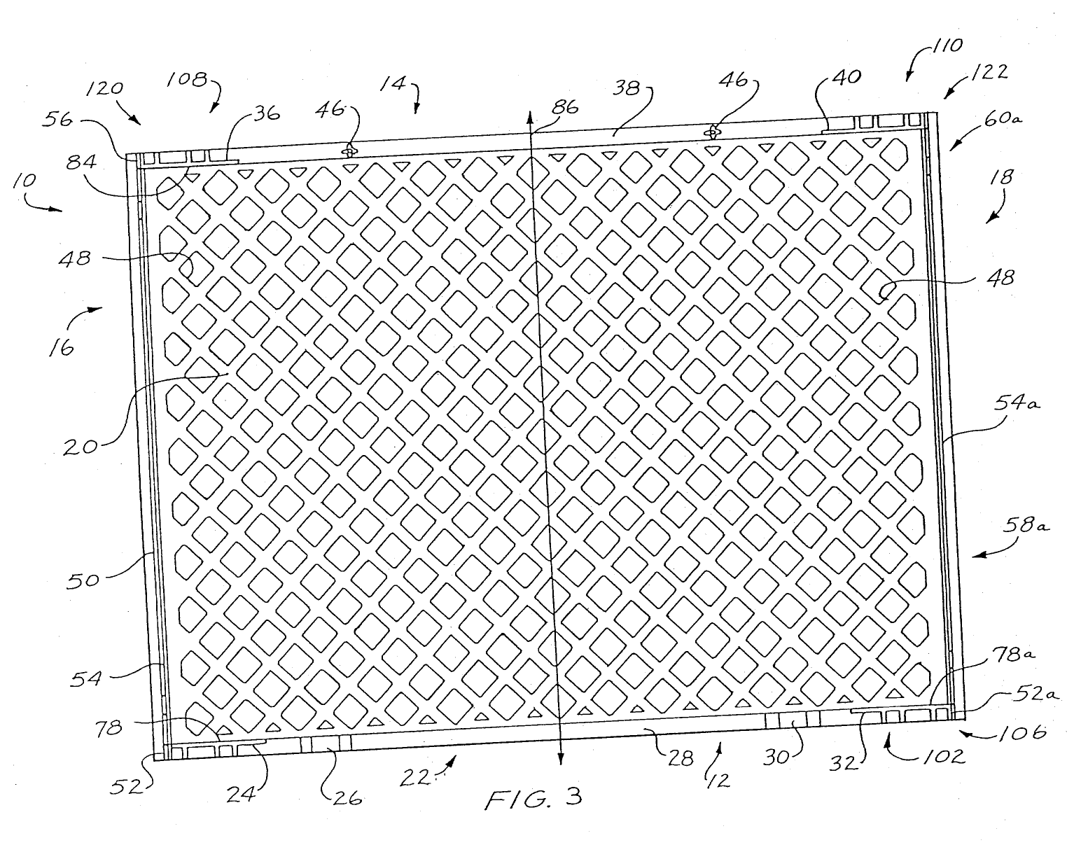

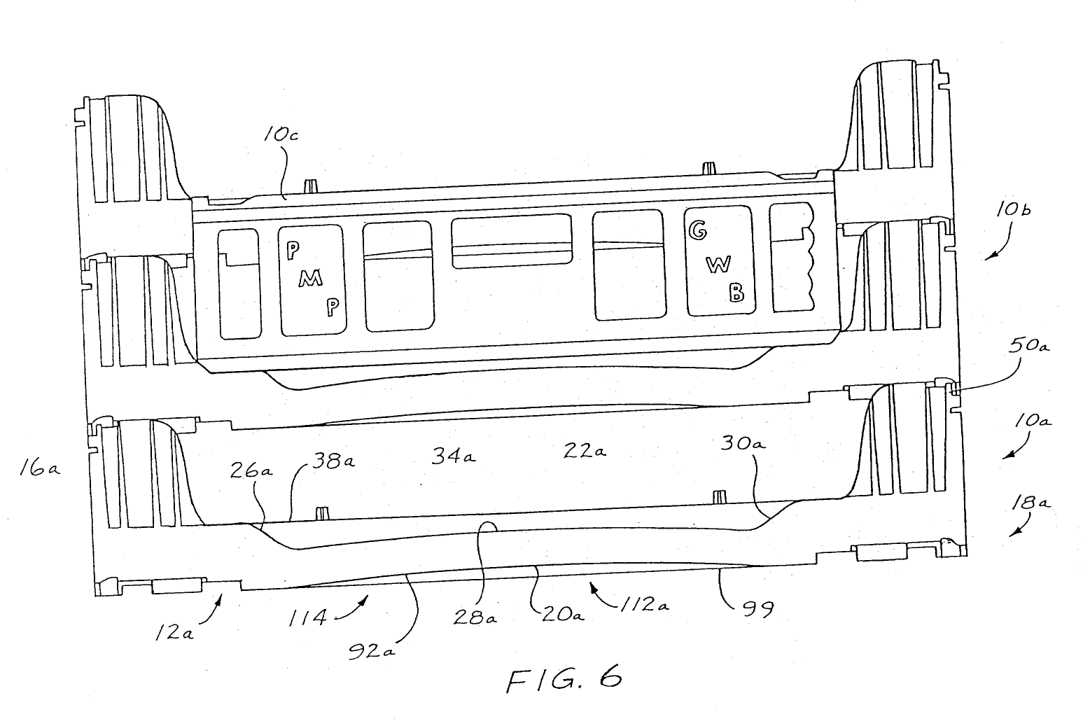

The rear 14 can also include one or more pins 46. When two trays are stacked at an angle of 180° relative to one another, the pins 46 can engage apertures 48 defined by the bottom 20. In FIG. 3, the apertures 48 are representative and may not indicate the precise aperture engaged by either of the pins 46. When the pin 46 is engaged with an aperture 48 of the bottom 20, movement of an upper tray relative to a lower tray is limited. FIG. 6 shows two trays 10b and 10c stacked at an angle of 180° relative to one another.

The first side 16 can be a mirror image of the second side 18 about an axis 86, best seen in FIG. 3. Both the first side 16 and the second side 18 can include a discontinuous runner 50 adjacent a top of the first side 16 and second side 18, respectively, for enhancing sliding engagement of two trays relative to one another. The runner 50 can include a front portion 52, a middle portion 54, and a rear portion 56. Each portion 52, 54, 56 is substantially longitudinally aligned with respect to one another. A first notch 58 can be disposed between the front portion 52 and the middle portion 54. A second notch 60 can be disposed between the middle portion 54 and the rear portion 56.

Each of the first side 16 and the second side 18 can also include a channel 62 defined in part by walls 64 and 66. The channel 62 can be disposed adjacent the bottom 20. Foot members 68 and 70 can be individually disposed at each end of the channel 62. One or more ribs 72 can be disposed along the length of the channel 62.

When two trays 10 are stacked at an angle of 0° relative to one another, middle portion 54 of the bottom tray is positioned in the channel 62 of the top tray between the foot members 68 and 70. Also, foot members 68 and 70 of the top tray can be positioned in the first notch 58 and second notch 60, respectively, of the bottom tray. As best seen in FIGS. 1, 2 and 4, a surface 74 of a member 76 can be disposed adjacent an inwardly facing surface 78 of the front 12. A surface 80 of a member 82 can be disposed adjacent an inwardly facing surface 84 of the rear 14.

Two trays 10 can be stacked at an angle of 180° relative to one another. When two trays 10 are stacked at an angle 180° relative to one another, a middle portion 54a of the bottom tray can be positioned in the channel 62 of the top tray between foot members 68 and 70. The middle portion 54 of the bottom tray can be positioned in the channel 62a of the top tray between the foot member 68a and 70a. Foot members 68a and 70a of the top tray are positioned in the second notch 60 and first notch 58, respectively, of the bottom tray. A surface 74a of a member 76a can be disposed adjacent the inwardly facing surface 84 of the rear 14. A surface 80a of member 82a can be disposed adjacent the inwardly facing surface 78 of the front 12.

Two trays 10 can be stacked at an angle of 90° relative to one another. When two trays 10 are stacked at an angle 90° relative to one another, walls 64 and 66 can be supported with the surface 38 as well as one of the surfaces 25, 27. Two trays 10 stacked at an angle of 90° relative to one another define a height that is less than a height defined by two trays stacked at an angle of 180° relative to one another, or a height defined by two trays 10 stacked at an angle of 0° relative to one another. The highest stacking height is achieved when two trays are stacked at either one of an angle of 0° with respect to one another or an angle of 180° with respect to one another. The lowest stacking height is achieved when the trays are stacked at an angle of 90° with respect to one another.

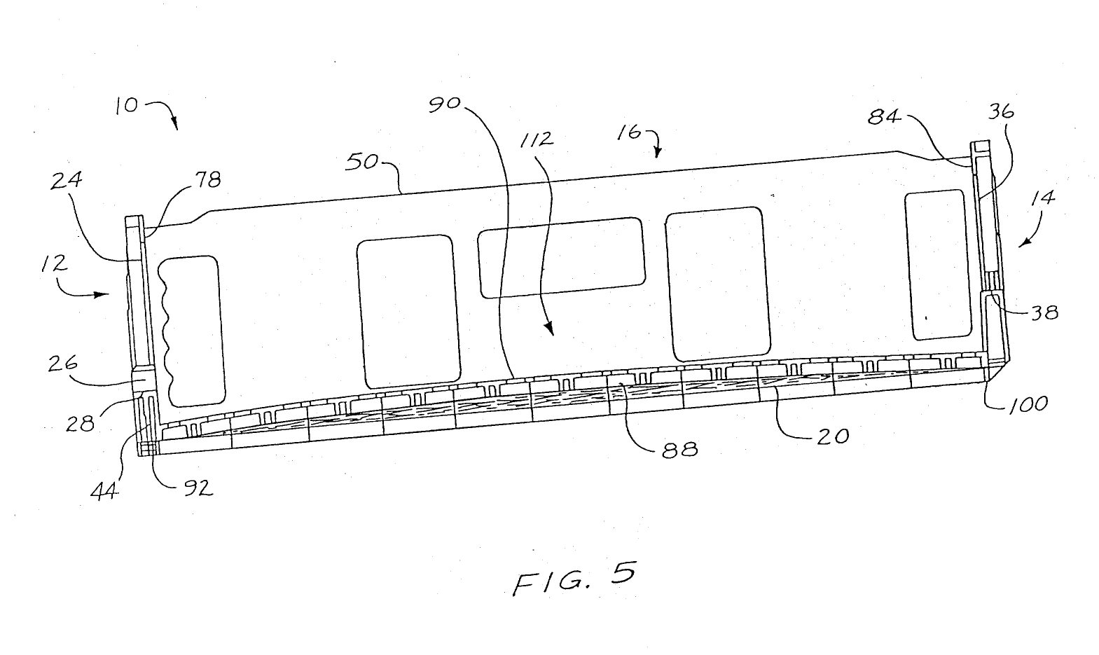

The present invention provides a tray having prestressed sections to enhance stacking of the trays and the structural integrity of individual trays. Specifically, the present invention provides a dome, or arched bottom, and inwardly angled front corners, best seen in FIGS. 5, 7, and 8. The domed bottom and angled corners can reduce the likelihood that a tray will sag when material and/or product is loaded with respect to the tray.

Referring now to FIG. 5, a cross-sectional view of a tray 10 having a domed bottom is shown. The cross-sectional view is taken generally from the longitudinal axis 86 of the tray 10. The domed bottom 20 includes an outwardly facing surface 88 and an inwardly facing surface 90. The bottom 20 can include an arcuate profile in two substantially perpendicular directions, along the longitudinal axis 86 of the tray and along a transverse axis of the tray. Preferably, the dome is three-eighths (⅜) of one inch at the center of the bottom 20 in height. In other words, the center of the dome extends towards the interior of the tray 10 three-eighths (⅜) of one inch relative to the intersection of the bottom 20 with the first side 16, the second side 18, the front 12, or the rear 14. Where the bottom is partially domed, arched, or partially arched, the center of the dome can extend towards the interior of the tray 10 three-eighths (⅜) of one inch relative to the intersection of any of the bottom 20 with the first side 16, the second side 18, the front 12, or the rear 14. However, the height of the dome can be increased or decreased as desired. The height of the dome can be varied based on the weight of the material and/or products to be maintained in the tray 10.

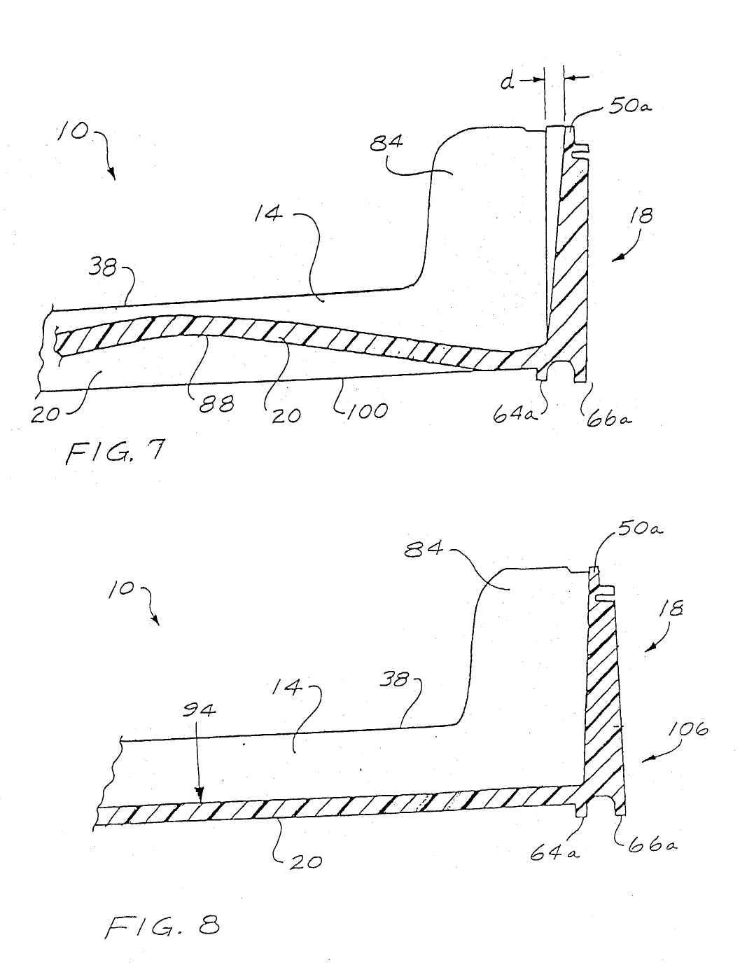

Referring now to FIG. 6, a portion 96a of the front 12a follows the profile of the partially-domed bottom 20a. The portion 96a can be centered with respect to the front between the first side 16a and the second side 18a and, more particularly, between the surfaces 26a and 30a to define a merchandising window. The bottom surface 92a of the front 12a along the portion 96a can be substantially parallel to the portion of the outwardly facing surface 88a of the bottom 20a adjacent the front 12a. The bottom 20a can engage the rear 14a of the tray 10a such that a bottom surface 99 of the rear 14a does not extend substantially parallel to the portion of the outwardly facing surface 88a of the bottom 20a adjacent the rear 14a. The top surface 28a of the portion 96a can extend substantially parallel to the bottom surface 92a. Preferably, the highest portion of the surface 28a can be one-half (½) of one inch higher than the center of the domed bottom 20a. FIG. 7 is a schematic view of the tray 10 in an unloaded or static condition. When the tray 10 receives material and/or goods to be maintained by the tray 10, the load 94 associated with the material and/or goods can deflect the tray 10 such that the surfaces 92 and 88, as well as the bottom 20, can be substantially horizontal, best seen in FIG. 8.

The present invention also provides outwardly angled front corners disposed between the front 12 and the first side 16, and the front 12 and second side 18, shown best in FIGS. 7 and 8. As shown in FIG. 7, a lower portion of the corner defined between the front (not shown) and the second side 18 can be angled inwardly toward a lower portion with respect to the tray 10 as the second side 18 extends from the rear 14 to the front (cut away). When material and/or products are received by the tray 10, represented by load arrow 94, the tray 10 can deflect such that the second side 18 adjacent the front is substantially horizontally aligned with the second side 18 adjacent the rear 14. Preferably, the horizontal transverse distance between the top portion of the second side 18 adjacent the rear 14 and the top portion of the second side 18 adjacent the front is one-half (½) inch. However, the distance d can be modified and be determined based on the material and/or product to be loaded with respect to the tray and the material of the tray. The walls 64a and 66a can be spaced apart to receive the runner 50a when the tray 10 is loaded or unloaded.

The tray 10 can include a front 12 having a first end 100, a second end 102 and first opening 22 disposed between the first and second ends 100, 102. The opening 22 can be substantially centered between the first and second ends 100, 102. The first opening 22 can be larger than the second opening 34. The first side 16 can extend from the first end 100 of the front 12, and a first corner 104 can be defined between the first side 16 and the front 12. The second side 18 can extend from the second end 102 of the front 12, and a second corner 106 can be defined between the second side 18 and the front 12. The rear 14 can include a first end 108 engageable with the first side 16 and a second end 110 engageable with the second side 18. The second opening 34 can be disposed between the first end 108 of the rear 14 and the second end 110 of the rear 14. The bottom 20 is operably associated with and extending between the front 12, rear 14, first side 16 and second side 18. The bottom 20 at least partially defines a dome 112 when the tray 10 is empty. The dome 112 is best shown in FIG. 5.

Referring now to FIG. 6, the opening 22a can include a surface 28a extending substantially parallel to at least a portion of the dome 112a defined by the bottom 20a. The surface 28a partially defines the opening 22a. When the tray 10a is empty, the surface 28a extends along an arcuate path. When the tray 10a is loaded, the surface 28a can become a substantially planar surface, flattening to be parallel with the dome 112a which also flattens when the tray 10a is subjected to a predetermined load, such as load 94 shown in FIG. 8. A surface 38a of the second opening 34a, defined by the rear, can be a planar surface when the tray 10a is supporting a predetermined load and when the tray is empty. A bottom portion 96a of the front 12a defines an arcuate surface 92a when the tray 10a is empty and a bottom portion 114 of the rear defines a substantially planar surface 99 when the tray 10a is empty.

In operation, when the tray 10 is subjected to a load, the lower ends of the first and second corners 104, 106 move away from one another, deflecting in response to the bottom 20 flattening into a more planar orientation. The channels 62 and 62a are sized to receive the first portions 52, 52a whether the tray 10 is loaded or empty. For example, when a bottom tray 10 is loaded, the front portions 52, 52a will be closer to one another than when the tray 10 is empty. The channels 62, 62a are sized to receive the front portions 52, 52a in both positions.

Third and fourth corners 120, 122 can be defined between the rear 14 and the first side 16 and the rear 14 and the second side 18, respectively. The third and fourth corners are spaced a predetermined distance apart from one another when the tray is loaded or empty. For example, the lower portions of the corners 104 and 106 move away from one another when the tray is loaded, however the third and fourth corners 120, 122 can be immovably associated with respect to one another.

When the tray 10 is loaded, at least a portion of one of the first and second sides 16, 18 can be twisted with respect to the bottom 20. For example, a top portion of the corner 106 can twist inwardly relative to the bottom 20 when the tray 10 is loaded, as best shown in FIGS. 7 and 8. A corresponding portion of the second side 18 adjacent the rear 14 can be fixed with respect to the bottom 20. As a result, an end of the second side 18 adjacent the front 12 can deflect and an end of the second side 18 adjacent the rear 14 can remain fixed and thus the second side 18 can twist when the tray 10 is subjected to a predetermined load 94. In addition, since the end of the second side 18 adjacent the rear 14 does not deflect and the end of the second side 18 adjacent the front 12 does deflect, the degree of deflection at any point along the length of the second side 18 increases along the length of the second side 18 from the rear 14 to the front 12.

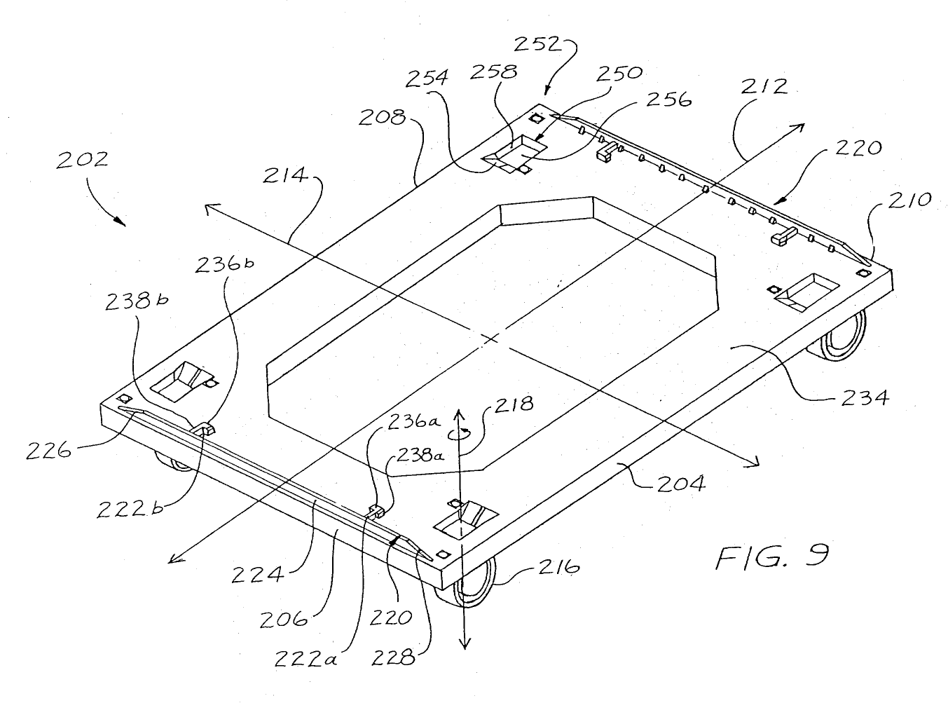

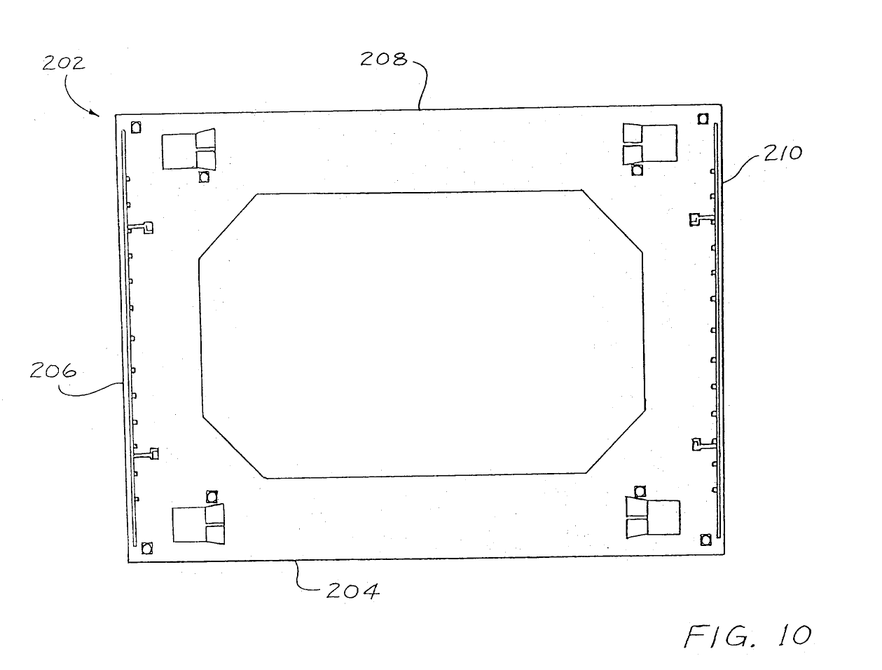

Referring now to FIGS. 9 and 10, the invention includes a stackable dolly 202 for supporting a stackable tray, such as the tray 10 shown and described with respect to FIGS. 1-8. The dolly 202 can include a first side 204, a second 206, a third side 208 and a fourth side 210. The first side 204 and third side 208 can be mirror images of one another with respect to a transverse axis 212. The second side 206 and fourth side 210 can be mirror images of one another with respect to a longitudinal axis 214. Casters or wheels 216 can be positioned at each corner of the dolly 202. Each caster or wheel 216 can be rotatable about a vertical axis 118 and about a horizontal axis.

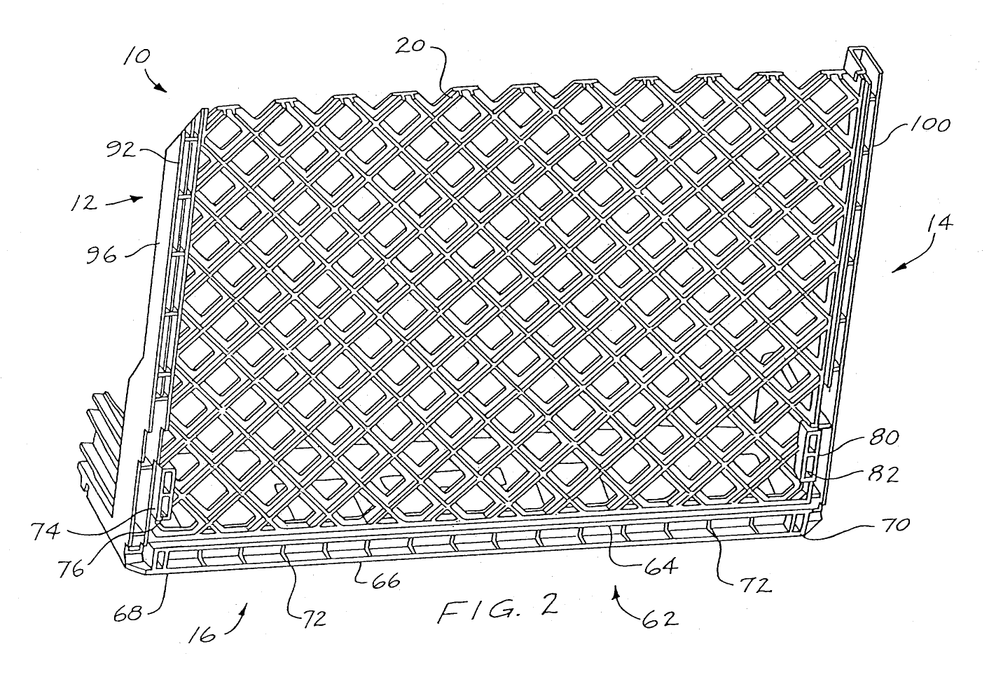

Referring now to FIGS. 2 and 9, the dolly 202 can support one or more trays, such as the tray 10 previously described. Dolly 202 includes a rails or ridges 220 formed on the upper surface 234 adjacent opposite ends. Each rail can include inwardly extending projections 222a, 222b for restricting movement of a tray relative to the dolly 202. When the tray 10 is positioned on the dolly 202, a center portion 224 of the rail 220 is disposed in the channel 62 of the tray between the foot member 68 and the foot member 70. The foot members 68 and 70 of the tray can contact ramp portions 226 and 228 of the rail 220. A bottom surface 130 of the side wall 64, a bottom surface 132 of the side wall 66, and the lower surfaces of the front wall 12 and rear wall 14 of the tray can engage the upper surface 234 of the dolly 202. Projections 222a and 222b can be formed on the upper surface 234 of the dolly 202 adjacent each rail 220. The projections 222a, 222b can include longitudinal portions 236a, 236b, respectively, and transverse portions 238a, 238b. The longitudinal portions 236a, 236b can be received by notches (not shown) in the wall 64 of the tray. The notches in the wall 64 of the tray can be positionable to receive the longitudinal portions 236a, 236b when the tray 10 is positioned on top of the dolly 202. The transverse portions 238a, 238b can limit transverse movement of the tray relative to the dolly 202, while the longitudinal portions 236a, 236b can limit longitudinal movement of the tray relative to the dolly 202. The tray can be disengaged from the dolly 202 by lifting or rotating the front wall 12 or the rear wall 14 of the tray relative to the dolly 202. For example, if the front wall 12 of the tray is lifted or rotated relative to the dolly 202 and the front wall 12 is positioned adjacent the first side 204 of the dolly 202, the foot member 70 of the tray can begin to slide up the ramp portion 226 of the rail 220. The foot member 70 of the tray can slide the length of the ramp portion 126 to engage the middle portion 124 to disengage the longitudinal portions 136a, 136b relative to the slots in the wall 64 of the tray.

The upper surface 234 of the dolly 202 can also include a recessed notch 250 adjacent each corner 252 for receiving the caster or wheel 216 of an adjacent upper dolly when dollys are stacked relative to one another. Each notch 250 can include a ramp portion 254 leading to a recessed surface 256 for trapping the upper caster or wheel during stacking of the dollys. The recessed surface 256 can be surrounded by at least one vertically extending side wall 258. The ramp portion 254 of the notches 250 can be aligned with one another and/or can be offset at angular orientations with respect to one another on the upper surface of the dolly 202 for improving stacking stability of the dollys. In the preferred configuration at least some of the ramp portions 254 of the notches 250 are offset at an angular orientation with respect to the other ramp portions 254 of the other notches 250. In the preferred configuration, the angular orientation offset is at lest equal to approximately 90° with respect to one another, and more preferably at least equal to approximately 180° with respect to one another, and most preferably the ramps 254 extend in a direction toward another ramp on an opposite side of the dolly 202 as illustrated in FIGS. 9 and 10. The ramps of the four notches can be configured to have at least two ramps extending in the same angular orientation with respect to one another, or can have all four ramps extending in different angular orientations with respect to one another.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A dolly for supporting stackable trays comprising:
a body having an upper surface and a plurality of casters connected to a bottom surface; and
a ridge extending along the upper surface for interacting with a tray to be stacked thereon for guiding sliding movement of the tray in at least one direction.

2. The dolly of claim 1, wherein the ridge has tapered ends for allowing the tray to be removed by lifting one edge of the tray to be removed and pulling the tray to be removed.

3. The dolly of claim 2, wherein the ridge further comprises at least two identical ridges extending generally parallel with respect to one another adjacent opposite sides of the body.

4. The dolly of claim 1 further comprising at least one locking projection formed on the upper surface for interacting with a tray to be stacked thereon for preventing movement of the tray in at least one direction.

5. The dolly of claim 4, wherein the locking projection prevents movement of the tray in at least two directions.

6. The dolly of claim 4, wherein the at least one locking projection extends outwardly from the ridge.

7. The dolly of claim 6, wherein the at least one locking projection prevents longitudinal movement of a stacked tray along the ridge.

8. The dolly of claim 1 further comprising at least one notch formed in the upper surface of the body for allowing a plurality of dollys to stacked with respect to one another, the at least one notch receiving the corresponding caster of an upper dolly to stacked thereon.

9. The dolly of claim 8, wherein the at least one notch includes an angled ramp portion.

10. The dolly of claim 9, wherein the at least one notch includes a recessed surface at least partially surrounded by at least one sidewall.

11. The dolly of claim 9, wherein the at least one notch further comprises a plurality of notches.

12. The dolly of claim 11, wherein the plurality of notches include angled ramp portions extending toward a common centerline of the body.

13. A dolly for supporting stackable trays comprising:
a body having an upper surface and a plurality of casters connected to a bottom surface;
at least two identical ridges extending generally parallel with respect to one another adjacent opposite sides of the body, each ridge extending along the upper surface for interacting with a tray to be stacked thereon for guiding sliding movement of the tray in at least one direction; and
at least one locking projection formed on the upper surface for interacting with a tray to be stacked thereon for preventing movement of the tray in at least one direction.

14. The dolly of claim 13, wherein the ridge has tapered ends for allowing the tray to be removed by lifting one edge of the tray to be removed and pulling the tray to be removed.

15. The dolly of claim 13, wherein the locking projection prevents movement of the tray in at least two directions.

16. The dolly of claim 13, wherein the at least one locking projection extends outwardly from the ridge.

17. The dolly of claim 16, wherein the at least one locking projection prevents longitudinal movement of a stacked tray along the ridge.

18. The dolly of claim 13 further comprising at least one notch formed in the upper surface of the body for allowing a plurality of dollys to stacked with respect to one another, the at least one notch receiving the corresponding caster of an upper dolly to stacked thereon.

19. The dolly of claim 18, wherein the at least one notch includes an angled ramp portion.

20. The dolly of claim 19, wherein the at least one notch includes a recessed surface at least partially surrounded by at least one sidewall.

21. The dolly of claim 19, wherein the at least one notch further comprises a plurality of notches.

22. The dolly of claim 21, wherein the plurality of notches include angled ramp portions extending toward a common centerline of the body.
